(19) United States
(12) Patent Application Publication
(10) Pub. No.: US 2019/0302257 A1
(43) Pub. Date: Oct. 3, 2019

(54) Method for Creating a 3D-Model and 3D-Body-Scanner

(71) Applicant: Naked Labs Austria GMBH, Wien (AT)

(72) Inventors: Farhad Farahbakhshian, Redwood City, CA (US); Gerhard Schultes, Unterpremstaetten (AT); William Nguyen, Redwood City, CA (US)

(21) Appl. No.: 16/316,838

(22) PCT Filed: Jul. 13, 2017
(86) PCT No.: PCT/EP2017/067667

§ 371 Date: Jan. 10, 2019

(30) Foreign Application Priority Data
Jul. 13, 2016 (DE) 10 2016 112 895.3

(51) Int. Cl. G01S 15/89; G01S 13/89; G01S 17/89; G01S 7/48

(52) U.S. Cl. CPC G01S 15/8993; G01S 13/89; G06T 2207/10028; G01S 7/4808; G06T 2207/30196; G01S 17/89

(57) ABSTRACT

A method for creating a 3D-Model of an object exposed in front of a number of stationary sensors mounted on a mast or carrier. The sensors include depth sensors, and the method includes turning the object around while scanning the object with the sensors. The method includes segmenting of the body and fitting a virtual skeleton in the segmented body with anatomically correct degrees of freedom. The method includes following the required motions of the body as it is turning around and performing non-rigid modelling of the shape of the body for one or more defined or normalized poses around the virtual skeleton. Furthermore, the invention relates to a 3D-Body-Scanner.

### CROSS-REFERENCE TO RELATED APPLICATIONS

The present application is related by subject matter to the following concurrently filed PCT applications (all of which designate the US):

a. International Application No.: PCT/EP2017/067668; entitled “Determination of Body Fat Content by Body-Volume-Distribution and Body-Impedance-Measurement”.

b. International Application No.: PCT/EP20171067669; entitled “Optical Marker to Adjust the Turntable of a 3D Body Scanner”.

c. International Application No.: PCT/EP2017/067761; entitled “Efficient Volumetric Reconstruction with Depth Sensors”.

d. International Application No.: PCT/2017/067672; entitled “Skeleton Estimation from Body Mesh”.

e. International Application No.: PCT/20171067667; entitled “Method for Creating a 3D-Model and 3D-Body-Scanner”.

f. International Application No.: PCT/2017/067664; entitled “Smart Body Analyzer with 3D Body Scanner and Vital Parameter Sensors”.

g. German Application No.: DE10 2016 112 895.3.

h. International Application No.: PCT/EP2017/067665; entitled “Motor Driven Turntable with Foldable Sensor Mast,” which claims priority to German Application No.: DE 10 2016 112 893.7.

i. International Application No.: PCT/EP2017/067671; entitled “Alignment of Scan Parts on a Turntable,” which claims priority to German Application No.: DE 10 2016 112 890.2.

The above cited applications are incorporated herein by reference for all purposes. Any combination of the features and aspects of the subject matter described in the cited applications may be combined with embodiments of the present application to yield still further embodiments of the present invention.

### FIELD OF THE INVENTION

The invention relates to a method for creating a 3D-Model of an object, which is turning around during a scanning process in front of one or a number of, in particular stationary, depth sensors mounted on a mast or carrier. Furthermore, the invention relates to a 3D-Body-Scanner.

### BACKGROUND OF THE INVENTION

Today accurate 3D human body models are demanded by various fields of applications as are:
Fitness and body styling applications,
Medical applications,
Cloth manufacturing industry,
Cloth internet and retail shops,
Automotive industry.

To generate 3D human body models 3D body scanners are used. The field of the disclosed invention deals with reducing the required mechanics and electronics of 3D body scanners but keeping the performance of 3D body model as recorded with conventional approaches.

To generate a 3D model of human body a 3D scanner is used. Such 3D body scanner uses whatever type of Depth Sensors (DS's) to determine the three dimensions of the body (object) to obtain a full set of information to generate the 3D body model. The body has to be seen by the DS's from multiple positions. In market leading 3D body scanners a motor driven relative motion of the body against one or more depth sensors is used to give the depth sensors a view of the body from all sides.

Today's 3D scanner works basically with four principles:
1. Moving depth sensors by hand freely around the body (object)
2. Rotating the body (object) in front of one or more depth sensors
3. Rotating or shifting the depth sensors in the surrounding of the body (object)
4. Multiple steady-state depth sensors around the body (object)
5. Combination of concepts above

If the body is in an as far as possible steady state pose and rotated by a turntable powered by a motor to give the DS's visibility to all sides of the body, there are the disadvantages of consuming to much space and the increasing costs caused by the turntable to rotate the body (object).

If the body is in an as far as possible steady state pose and DS's are rotated by a mechanics powered by a motor around the body to give them visibility to all sides of the body, this structure is very sensitive against damage and the rotation mechanism is very expensive.

If the DS's are placed fix in two or more positions around the body to give the 3D scanner visibility to all sides of the body, this is very space consuming, the high number of depth sensors is expensive and it is complicated and time consuming in preparing and setting up.

Combined concepts typically use a motor powered turntable to turn the body (object) around and move one depth sensor that is motor powered to move linearly in height instead of using multiple depth sensors at different constant heights. Using only a single depth sensor causes increasing costs by a very complicated mechanical construction and long scanning times, consequently this reduces accuracy when the body undergoes natural body motion.

To create a 3D model of a body (object) with the concepts described in the state of the art, there is a relative motion between the body and one or more depth sensors needed to give the depth sensors view from all sides of the body.

This is typically realized (i) that the body is moved in front of stationary depth sensors or (ii) the depth sensors have to be moved around the body (object) in order to give the DS's full visibility of the body (object). This motion is done by one or more motors that move in a circular or linear way. The body is assumed to be steady state, stiff or rigid and making no motions during the scanning process. However when scanning an alive human body, this assumption is not true. The body naturally moves slowly forward and backward to stay in balance while standing. Furthermore, breathing shifts slightly the center of gravity and the heart beat modulates the surface of the chest.

Consequently to obtain a comparable scan, such natural body motions have to be corrected for such motions.

From scan precision, cost and space consumption, the concepts are most competitive and future oriented.

From the WO 2014/037939 A (U.S. Pat. No. 9,727,787, which is hereby incorporated herein by this reference for all purposes), a method for deriving accurate body size measures of a user from a sequence of 3D images is known.

### BRIEF OBJECTS AND SUMMARY OF THE INVENTION

The object of the present invention is to provide a method for generating an improved 3D-Model.

The aforementioned object is achieved by the features disclosed in the method and apparatus described below.

Proposed is a method for creating a 3D-Model of an object, which is turning around during a scanning process in front of one or a number of, in particular stationary, depth sensors mounted on a mast or carrier. The scanning process includes steps of scanning, segmenting, fitting and modelling the 3D-Model. The person is scanned while the person uses the person's legs to move around in front of the depth scanners. Meanwhile the body is segmented into parts. Afterwards a virtual skeleton is fitted into the segmented body with anatomic correct degrees of freedom, which follows the required motions of the body's turnaround. Subsequent the body shape for one or more defined or normalized poses around the virtual skeleton is non rigidly modelled.

If 3D models, recorded at different times, shall be compared, it is normal that the pose at different events is not exactly the same. Therefore, some pose normalization has to be done by post processing by using some a-priory information about the body mechanics (degree of freedom of the joints) and individual parameters (length of the limbs) of the body to be scanned.

The invented method extends the concept of dealing with a slightly moving, non-rigid alive body to avoid the mechanics to turn around the body with e.g. a turntable or to move around the depth sensors with circular and/or linear or spiral like motion.

It is an advantage to separate the body mathematically into individual body parts, in particular at least head, chest and limbs.

For simplifying the non-rigid modelling it is an advantage to make some pose normalization by using a-priory information about individual parameters, in particular the length of the limbs, of the body to be scanned.

It is an advantage to compare body shapes which are recorded at different times, whereby the poses of the body are significant different. It might be useful to compare the body shapes which are recorded within one day. The poses might be recorded from different directions.

A further advantage is composing the virtual skeleton by bones and joints.

Proposed is a 3D-Body-Scanner for creating a 3D-Model of an object. The 3D-Body-Scanner comprises a mast or a carrier and one or a number of, in particular stationary, depth sensors mounted on the mast or the carrier for recording an object which is turning around. The 3D-Body-Scanner is designed to operate with a method for creating a 3D-Model according to one or more of the following or preceding characteristics of the description.

The invented method avoids the motorized driven relative motion between the body to be scanned moving the depth sensors and therewith saves a major part of hardware of such 3D body scanners.

Therefore, the person to be scanned slowly moves around itself by motion of its legs. An advanced 3D fusion process is creating the 3D model of the body using skeletonization and a non-rigid modeling technique to calculate the dimensions of the slowly moving body parts.

The resulting 3D body model is then presented in a pre-defined normalized body pose and can be used for accurate tracking of body development over time.

### BRIEF DESCRIPTION OF THE DRAWING

The accompanying drawing, which is incorporated in and constitutes a part of this specification, illustrates at least one presently preferred embodiment of the invention. This drawing, together with the written description, serves to explain the principles of the invention but by no means is intended to be exhaustive of all of the possible manifestations of the invention. The drawings schematically show in:

FIG. 1 a self-moving person and segmentation and skeletonization for creating the 3D body model.

Additional advantages of the invention are described in the following exemplary embodiments.

### DETAILED DESCRIPTION OF EXEMPLARY EMBODIMENTS OF THE INVENTION

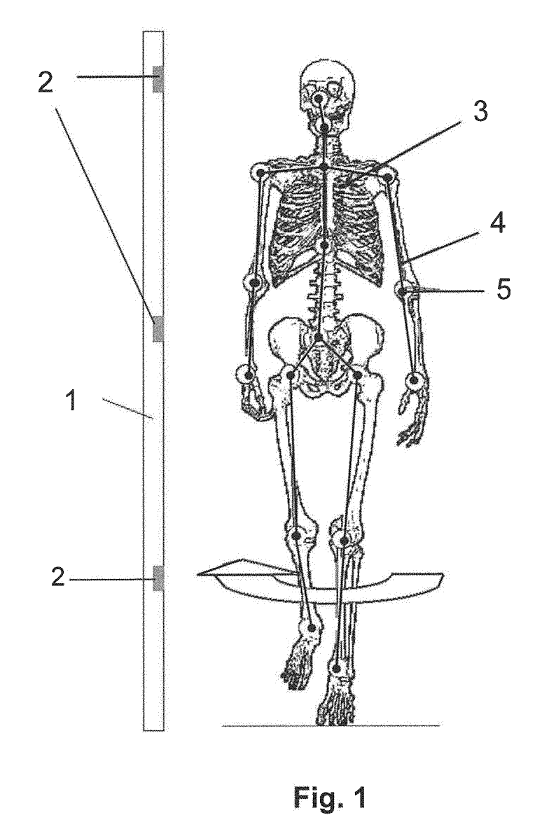

Therefore, as schematically depicted in FIG. 1, the person 3 to be scanned slowly moves around itself by motion of the person's legs. The 3D fusion process itself creating the 3D model uses segmentation, skeletonization, and a non-rigid modeling technique, to calculate the dimensions of the moving body parts.

The resulting 3D body model is then presented in a pre-defined normalized body pose. Segmentation means the mathematical separation of the body 3 into the head, chest and limbs. Skeletonization means that a virtual skeleton of stiff, bone 4 like elements and joints 5 of assumed freedom is fitted into the segmented body. Non rigid body modeling means that a 3D body model in a normalized position is created using the segmentation and the skeletonization.

It should be clear that the resulting 3D body model is not exactly in the pose the person 3 has at starting or finishing of the scan.

The advantages of the described method are that heavy motorized mechanics for body or depth sensor motion can be omitted. Furthermore, one part of a conventional 3D body scanner, including its energy supply and communication link is removed. The space consumption of the scanner is strongly reduced. The production costs are strongly reduced.

A 3D body scanner is consisting only of a mast or carrier 1 where on which one or a number of depth sensors 2 are mounted and accordingly fully omitting another part usually needed for bringing the body 3 in motion.

The relative motion between the body 3 and the depth sensors 2 on a mast or on a carrier 1 is provided in an advantageous way by the body 3 to be scanned itself whereas the deformation of the body 3 to perform this relative motion is accepted.

The calculation (3D fusion) of the body model is performed in an advantageous way at turning around of the body 3 during the scanning process by at first segmentation of the body 3 into the main body, limbs and head followed by fitting in a virtual skeleton composed by stiff bones 4 and joints 5 with anatomic correct degrees of freedom, which follows the required motions of the bodies during turnaround. Finally, the shape of the body 3 is modeled for one or more defined or normalized poses by non-rigid modeling of the body shape around the virtual skeleton, which is composed respectively of bones 4, and joints 5.

The calculation (3D fusion) of the 3D body model for one or more defined or normalized poses enables a precise comparison of body shapes recorded at different times where the pose of the body during the turn-around motions may be significantly different.

In market leading 3D body scanner concepts, a motor driven relative motion of the body 3 against one or more depth sensors 2 is used to give the depth sensors 2 a view of the body from all sides.

The invented device and method avoids the need for motors to drive relative motion between the body 3 and the depth sensors 2 and therewith saves a major part of hardware of such 3D body scanners.

As invented, it is the person 3 to be scanned who slowly moves around in front of the scanners by motion of the person's own legs.

An advanced 3D fusion process is creating the 3D model of the body 3 for one or more normalized poses using body segmentation, skeletonization and a non-rigid modeling technique to calculate the dimensions of the slowly moving body parts.

The 3D scan result may be presented in normalized poses and allows also accurate comparisons of body scans recorded at different times.

The invention is not limited to the embodiments shown or described. Rather, any and all combinations of the individual features described, as shown in the FIGURE or described in the description, and to the extent that a corresponding combination appears possible and sensible, are subject matters of the invention.

1. Method for creating a 3D-Model of an object, which is turning around during a scanning process in front of a number of stationary depth sensors mounted on a mast or carrier, wherein the method includes the following steps:
using the depth sensors for scanning the object which moves around itself by motion of its legs,
segmenting of a body,
fitting a virtual skeleton in the segmented body with anatomic correct degrees of freedom, which follows the required motions of the bodies turnaround,
non rigid modelling the body shape for one or more defined or normalized poses around the virtual skeleton.

2. Method according to claim 1, wherein the body is mathematically separated in body parts, which include a head, a chest and limbs.

3. Method according to claim 1, wherein the virtual skeleton is composed by bones and joints.

4. Method according to claim 1, wherein some pose normalization is made by using a-priory information about individual parameters, in particular the length of the limbs, of the body to be scanned.

5. Method according to claim 1, wherein body shapes recorded at different times, in particular within one day, whereby the poses of the body are significant different, in particular from different directions, are compared.

6. 3D-Body-Scanner for creating a 3D-Model of an object comprising:
a mast or a carrier and
one or a number of, in particular stationary, depth sensors mounted on the mast or the carrier for recording an object which is itself turning around,
wherein the 3D-Body-Scanner is designed to operate with a method for creating a 3D-Model of an object in one or several of the previous claims.
